(19) United States
(12) Patent Application Publication
(10) Pub. No.: US 2014/0250075 A1
(43) Pub. Date: Sep. 4, 2014

(54) USING A FILE SYSTEM INTERFACE TO ACCESS A REMOTE STORAGE SYSTEM

(71) Applicants: Jacob Broido, Tel Aviv (IL); Cyril Plisko, Petah Tikvah (IL); Kariel Sandler, Bat Hefer (IL)

(72) Inventors: Jacob Broido, Tel Aviv (IL); Cyril Plisko, Petah Tikvah (IL); Kariel Sandler, Bat Hefer (IL)

(21) Appl. No.: 13/783,310

(22) Filed: Mar. 3, 2013

(51) Int. Cl. G06F 17/30

(52) U.S. Cl. CPC G06F 17/30174
USPC 707/639

(57) ABSTRACT

A non-transitory computer readable medium that may store instructions for receiving, by a local storage system, a file system command that is sent from a host computer, the file system command is related to a remote snapshot of a local file system entity; wherein the remote snapshot of the local file system entity is generated by a process that may include sending a snapshot of the local file system entity from the local storage system to a remote storage system; wherein the local file system entity belongs to a local file system stored at the local storage system; and responding to the file system command, wherein the responding may include utilizing or generating remote snapshot file system information that is representative of the remote snapshot of the local file system entity.

### BACKGROUND

Remote Snapshots

File-based remote replication is a solution that replicates changes in a local file system on a local storage system to a remote file system on a remote storage system. The replication can be of a single directory, a sub-tree or an entire file system from the local file system to the remote file system.

A directory can include other directories and/or files. A directory that belongs to another directory can be referred to as a sub-directory. For simplicity of explanation these terms (directory and sub-directory) are used in an interchangeable manner.

A replication usually relies on snapshots so as to transfer a consistent version of the local file system to the remote storage system. At the remote storage system, the snapshots can optionally be offloaded to tape. After a certain snapshot is replicated to the remote storage system, it may be deleted from the local storage system so as to reclaim space.

Local File System Operations

Modern NAS file servers provide a file restoration service that is available to an end-client through in-band management access, without requiring involvement of a system administrator. This is typically done by configuring each directory, DIR, in a local file system to include a virtual local snapshots directory that is denoted ‘.snap shot’. The virtual local snapshots directory (.snapshot) includes a virtual local snapshot directory per each available snapshot stored in the local storage system.

For example, virtual local snapshot directory .snapshot/snap1 that resides under the directory DIR relates to a first point in time snapshot (denoted ‘snap1’) of DIR.

Each virtual local snapshot directory may include a complete copy of the parent directory, DIR, as existed at the local storage system at the point in time the snapshot was created. If a file, F, under DIR is corrupted or deleted, it can still be found (or at least an older point in time version thereof) under each of the virtual local snapshot directories under .snapshot. Assuming that for a file there are two snapshots (first point in time snapshot snap1 and second point in time snapshot snap2), then these snapshots can be found, for example, through each one of the following paths: .snapshot/snap1/F, .snapshot/snap2/F, corresponding to snapshots titled snap1, snap2.

FIG. 1 illustrates a prior art directory tree 8 of a file system that represents a local file system that includes a root directory D0 10 and another directory D1 20 that resides under D0. FIG. 1 also illustrates a file F 30 that resides under D1 20 and D0 10. The directories D1 and D0 further host two virtual local snapshots directories .snapshot 52 and .snapshot 51, respectively.

Snapshots may be accessed by navigating through virtual directories. In this example, there are two snapshots available to the user and therefore each one of .snapshot 51 and .snapshot 52 includes two virtual local snapshot directories snap1 and snap2, a virtual local snapshot directory for each of the accessible snapshots.

Virtual local snapshots directory .snapshot 51 includes virtual local snapshot directories snap1 53A and snap2 53B. Virtual local snapshot directory snap1 53A includes a first point of time snapshot snap1 30A of file F. Virtual local snapshot directory snap2 53B includes a second point of time snapshot snap2 30B of file F 30.

Virtual local snapshots directory .snapshot 52 includes virtual local snapshot directories snap1 54A and snap2 54B.

Virtual local snapshot directory snap1 54A includes a virtual local sub-directory D1 55A that includes a first point in time version of directory D1, and this first point in time version of D1 includes a first point in time snapshot 30A of file F.

Virtual local snapshot directory snap2 54B includes a virtual local sub-directory D1 55B that includes a second point in time version of directory D1, and this second point in time version of D1 includes a second point in time snapshot 30B of file F.

Table 1 illustrates the relationships between the directories and virtual directories of directory tree 8. The rows of table 1 represent levels of hierarchy in the directory tree 8. Each cell of the table represents a part of the directory tree 8 that includes all the parts that are represented by cells of the table that are directly below that cell. For example, the first level of directory tree 8 represents directory D0 10. D0 10 includes directory D1 20 and virtual local snapshots directory .snapshot 52. Accordingly—the cells that represent D1 20 and .snapshot 52 are directly below (column-wise) the cell that represents D0 10.

TABLE 1

| Level | | |
|---|---|---|
| 1 | DO 10 | |
| 2 | D1 20 | .snapshot 52 |

| | | | | |
|---|---|---|---|---|
| 3 | F 30 | .snapshot 51 | snap1 54A | snap2 54B |

| | | | | |
|---|---|---|---|---|
| 4 | snap1 | snap2 | D1 55A | D1 55B |
| | 53A | 53B | | |
| 5 | 30A | 30B | 30A | 30B |

First point in time snapshot (snap1) 30A of file F 30 is accessible via one of two paths: (i) D0/.snapshot/snap1/D1/F; or (ii) D0/D1/.snapshot/snap1/F, so that in case where the original D1 directory 20 is deleted (and thus the underneath virtual directory .snapshot 51 is not available anymore via the second path), snapshots of F can still be accessed via the first path.

Typically, the virtual local snapshot directories and the virtual local sub-directories are invisible and usually do not appear when requesting directory content list (e.g. UNIX ls command) of directories 10 and 20, but a change-directory command (e.g. UNIX cd command), indicating ‘.snapshot’ as parameter (e.g. ‘cd D0/.snapshot’), will change the current directory to the virtual local snapshots directory ‘.snapshot’. Likewise, a listing command will list all directories under the virtual directory .snapshot, for example, the command ‘ls .snapshot’ will list virtual local snapshot directories snap1 and snap2 and ‘ls .snapshot/snap2’ will list virtual local sub-directory D1 55B (which includes the second point time snapshot 30B of file F 30).

Local copy commands are also available for a local snapshot version of the file for recovering an older local version of the file from the local storage system. For example, version 30A of file F can be copied to another local directory hosted by the local storage system.

Clients connected to the local storage system have no way to use the virtual directories for accessing snapshot data stored on the remote storage system.

There is a need to provide such access, especially when there is a need to retrieve snapshots of files that were deleted from the local storage system.

### SUMMARY

According to an embodiment of the invention various methods may be provided and are described in the specification. According to various embodiments of the invention there may be provided a non-transitory computer readable medium that may store instructions for performing any of the methods described in the specification and any steps thereof, including any combinations of same. Additional embodiments of the invention include a storage system arranged to execute any or all of the methods described in the specification above, including any stages—and any combinations of same.

According to an embodiment of the invention there may be provided a non-transitory computer readable medium that may store instructions for receiving, by a local storage system, a file system command that is sent from a host computer, the file system command is related to a remote snapshot of a local file system entity; wherein the remote snapshot of the local file system entity is generated by a process that may include sending a snapshot of the local file system entity from the local storage system to a remote storage system; wherein the local file system entity belongs to a local file system stored at the local storage system; and responding to the file system command, wherein the responding may include utilizing or generating remote snapshot file system information that is representative of the remote snapshot of the local file system entity.

The non-transitory computer readable medium may store instructions for sending the snapshot of the local file system entity from the local storage system to the remote storage system.

The non-transitory computer readable medium may store instructions for requesting from the remote storage system the remote snapshot file system information in response to the receiving of the file system command.

The non-transitory computer readable medium may store instructions for requesting from the remote storage system the remote snapshot in response to the receiving of the file system command.

The non-transitory computer readable medium may store instructions for preventing the remote storage system from changing a status of the remote snapshot of the local file system entity.

The non-transitory computer readable medium may store instructions for generating a hybrid file system sub-tree that may include (a) a local file system sub-tree that represents a portion of the local file system and (b) at least one remote file system sub-tree that represents at least one remote snapshot of at least one local file system entity.

The non-transitory computer readable medium may store instructions for sending to the host computer information that causes the host computer to display to the end user the hybrid file system tree.

The non-transitory computer readable medium may store instructions for generating the hybrid file system sub-tree to comprise a virtual snapshots directory that represents (a) locally stored snapshots of entities of the local file system, and (b) at least one remote snapshot of at least one local file system entity, wherein the at least one remote snapshot is stored at the remote storage system.

The non-transitory computer readable medium may store instructions for generating a remote file system sub-tree that represents at least one remote snapshot of at least one local file system entity.

The non-transitory computer readable medium may store instructions for sending to the host computer information that causes the host computer to display to the end user the remote file system sub-tree.

The remote file system sub-tree may include a virtual directory that represents the at least one remote snapshot of the at least one local file system entity and wherein the file system command may include a standard file system command and a reference to the virtual directory.

The file system command may be sent from a host computer without using system administrator privileges.

The file system command may include a request to create the remote snapshot of the local file system entity and wherein the non-transitory computer readable medium may store instructions for responding to the file system command by sending the snapshot of the local file system entity from the local storage system to the remote storage system and generating the remote snapshot file system information.

The non-transitory computer readable medium may store instructions for responding to the file system command without generating a local snapshot of the local file system entity.

The file system command may include a request to delete the remote snapshot of the local file system entity and wherein the non-transitory computer readable medium may store instructions for responding to the file system command by requesting from the remote storage system to delete the remote snapshot of the local file system entity.

The file system command may include a request to copy the remote snapshot of the local file system entity from the remote storage system to the local storage system; wherein the non-transitory computer readable medium may store instructions for responding to the file system command by requesting from the remote storage system to send to the local storage system the remote snapshot of the local file system entity.

According to an embodiment of the invention there may be provided a method that may include receiving, by a local storage system, a file system command that is related to a remote snapshot of a local file system entity; wherein the remote snapshot of the local file system entity is generated by a process that may include sending a snapshot of the local file system entity from the local storage system to a remote storage system; wherein the local file system entity belongs to local file system stored at the local storage system; and responding to the file system command, wherein the responding may include utilizing or generating remote snapshot file system information that is representative of the remote snapshot of the local file system entity.

According to an embodiment of the invention there may be provided a local storage system that may include a communication module that is arranged to receive a file system command that is related to a remote snapshot of a local file system entity; wherein the remote snapshot of the local file system entity is generated by a process that may include sending a snapshot of the local file system entity from the local storage system to a remote storage system; wherein the local file system entity belongs to local file system stored at the local storage system; and a file system manager that is arranged to receive from the communication module the file system command and to manage a response to the file system command, wherein the response may include utilizing or generating remote snapshot file system information that is representative of the remote snapshot of the local file system entity.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a prior art directory-tree of a file system;

FIG. 2 illustrates a hybrid file system sub-tree according to an embodiment of the invention;

FIG. 3 illustrates a local storage system, a remote storage system and their environment according to an embodiment of the invention; and

FIG. 4 illustrates a method according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

The terms “local storage system” and “remote storage system” refer to storage systems that differ from each other. These storage systems can be spaced apart from each other, located at a large distance from each other or may be proximate to each other.

The term snapshot version and the term snapshot timestamp are used in an interchangeable manner in the following text.

The term local snapshot refers to a snapshot that is stored in a local storage system.

The term remote snapshot refers to a snapshot that is stored in a remote storage system.

The term “virtual directory” refers to a directory which is presented to a user as if it is cataloged under a certain parent directory, but is not actually a directory that exists under the certain parent directory nor does it exist elsewhere in the directory tree of the file system.

The term “virtual local snapshots directory” refers to a virtual directory that facilitates access to multiple local snapshots.

The term “virtual local snapshot directory” refers to a virtual directory that facilitates access to a single local snapshot.

The term “virtual remote snapshots directory” refers to a virtual directory that facilitates access to multiple remote snapshots.

The term “virtual remote snapshot directory” refers to a virtual directory that facilitates access to a single remote snapshot.

The term “virtual hybrid snapshots directory” refers to a virtual directory that facilitates access to multiple snapshots that include at least one local snapshot and at least one remote snapshot.

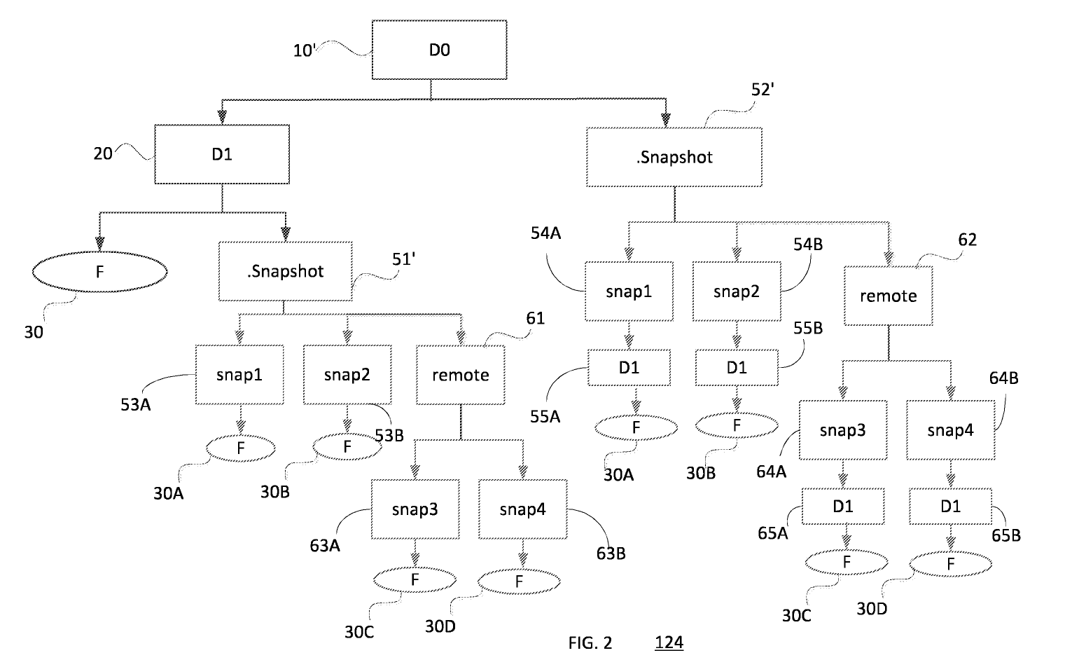

The term “local file system entity” refers to a part of a local file system or to the entire local file system. Non-limiting examples of such an entity include one or more files, one or more sub-directories, one or more directories, a sub-tree of directories, and the like. FIG. 2 illustrates a hybrid file system sub-tree 124 according to an embodiment of the invention.

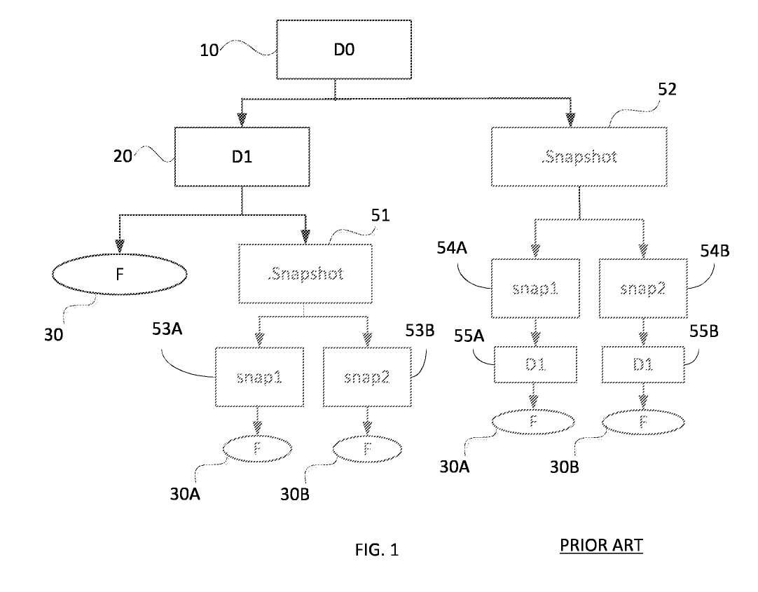

Hybrid file system sub-tree 124 differs from directory tree 8 of FIG. 1 by:
A. Including virtual hybrid snapshots directories 51′ and 52′ instead of virtual local snapshots directories 51 and 52.
B. Including virtual remote snapshots directories 61 and 62.
C. Including virtual remote snapshot directories 63A, 63B, 64A and 64B.
D. Including virtual remote sub-directories D2 65A and 65B.

The hybrid file system sub-tree 124 facilitates access to remote snapshots 65A and 65B of sub-directory D1 along with all the content thereof, such as remote snapshots 30C and 30D of file F 30.

The remote snapshots 30C and 30D can be third and fourth point in time snapshots of file 30. The third and fourth points in time may differ from the first and second points in time. Accordingly—remote snapshots 30C and 30D may differ from local snapshots 30A and 30B.

Table 2 illustrates the relationships between the directories and virtual directories of hybrid file system sub-tree 124. The rows of table 2 represent levels of hierarchy in the hybrid file system sub-tree 124.

TABLE 2

| Level | | | | | | | | | |
|---|---|---|---|---|---|---|---|---|---|
| 1 | D0 10’ | | | | | | | | |
| 2 | D1 20 | | | | .snapshot 52’ | | | | |
| 3 | F 30 | .snapshot 51’ | | | | snap1 | snap2 | remote 62 | |
| | | | | | | 54A | 54B | | |
| 4 | | snap1 | snap2 | remote 61 | | D1 | D1 | snap3 | snap4 |
| | | 53A | 53B | | | 55A | 55B | 64A | 64B |
| 5 | | 30A | 30B | snap3 | snap4 | 30A | 30C | D1 | D1 |
| | | | | 63A | 63B | | | 65A | 65B |
| 6 | | | | 30C | 30D | | | 30C | 30D |

Hybrid file system sub-tree 124 includes a root directory D0 10′ and another directory D1 20 that resides under D0. FIG. 2 also illustrates a file F 30 that resides under D1 20 and D0 10′. The directories D1 and D0 further host two virtual hybrid snapshots directories .snapshot 52′ and .snapshot 51′, respectively. Each one of two virtual hybrid snapshots directories .snapshot 52′ and .snapshot 51′ is hybrid in the sense that it includes local file system and remote file system elements.

Each one of virtual hybrid snapshots directories snapshot 51′ and .snapshot 52′ includes two virtual local snapshot directories snap1 and snap2, and a virtual remote snapshots directory.

Virtual remote snapshots directory 61 (belongs to .snapshot 51′) includes two virtual remote snapshot directories—snap3 63A and snap4 63B—corresponding to third and fourth point of time snapshots 30C and 30D of file F.

Virtual remote snapshots directory 62 (belongs to .snapshot 52′) includes two virtual remote snapshot directories—snap3 64A and snap4 64B under remote 62—corresponding to third and fourth point of time snapshots of the sub-tree under D0, such as 65A and 65B of sub-directory D1, including all the content thereof, in this case, third and fourth point in time snapshots 30C and 30D of file F.

Virtual remote snapshot directory snap3 64A includes a virtual remote sub-directory D1 65A that includes a third point in time version of directory D1, and this third point in time version of D1 includes a third point in time snapshot 30C of file F.

Virtual remote snapshot directory snap3 64A includes a virtual remote sub-directory D1 65B that includes a fourth point in time version of directory D1, and this fourth point in time version of D1 includes a fourth point in time snapshot 30D of file F.

The hybrid file system sub-tree 124 includes portions of remote and local file systems. It may include only portions of a remote file system.

According to another embodiment of the invention, the virtual remote snapshot directories (e.g. snap3, 63A and 64A, and snap4 63B and 64B) may reside directly under the virtual hybrid snapshots directories, .snapshot 51′ and .snapshot 52′, side by side with virtual local snapshot directories snap1 and snap2, with or without indication for these virtual directories being remote directories.

It is noted that the hybrid file system sub-tree of FIG. 2 is only an example of a hybrid file system sub-tree and that the number of directories, levels of hierarchy, number of files and number of snapshots (local and remote) can differ from those illustrated in FIG. 2. For example, the number of virtual remote snapshots directories can exceed one-especially if the hybrid file system sub-tree includes remote snapshots from more than a single remote storage system. Yet for another examples—each directory can include multiple sub-directories and files, the number of files of one or more directory can change over time, and there can be much more than two snapshots per storage system. The hybrid file system sub-tree of FIG. 2 can also represent an entire directory tree of a file system, denoted hybrid directory tree.

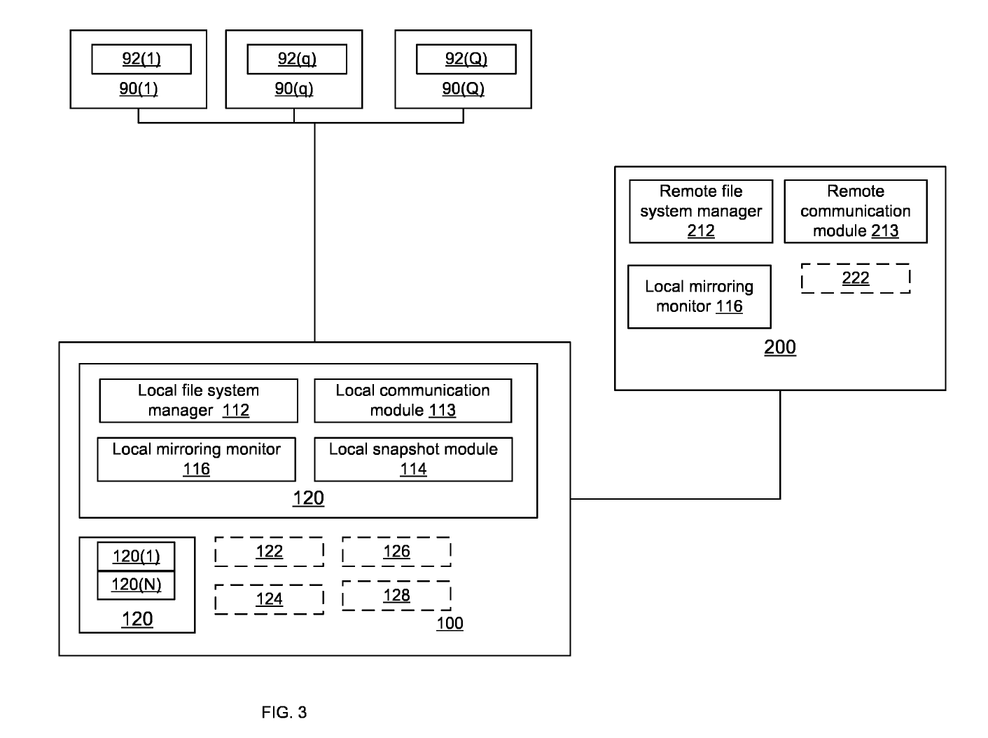

FIG. 3 illustrates a local storage system 100, a remote storage system 200 and their environment according to an embodiment of the invention.

Local storage system 100 can be accessed by multiple host computers 90(1)-90(Q) operated by end users, which are users that operates the host computers. Each one of the host computers 90(1)-90(Q) can read data from the local storage system 100 or write data to the local storage system 100 or perform any other access operation related to directories, files and other logical objects stored in one or more file systems managed by local storage system 100. Host computers 90(1)-90(Q) communicate with local storage system 100 using file system commands of a file system protocol, such as NFS and CIFS.

Local storage system 100 handles the cached and stored data in portions, referred herein as ‘data units’. Each data unit is associated with a logical address of a logical address space. The logical address space may be much larger that the physical address space supported by the local storage system 100.

The storage system 100 includes a cache and management layer 110 and a hard disk drives (HDDs) layer 120. The HDDs layer 120 includes multiple hard disk drives 120(1)-120(N). The HDDs layer 120 supports a physical address space.

The cache and management layer 110 is arranged to handle read and write requests (and any other filesystem related requests supported by the file system protocol) received from host computers 90(1)-90(Q) and directed to data and metadata of filesystem elements (e.g. files and directories) stored in hard disk drives (HDDs) layer 120. The read and write requests received from host computers 90(1)-90(Q) are indicative of the file system identifier (or the identifier of the logical volume that hosts the filesystem), a file (e.g. an inode number, a file name) and offsets within the file to be read from/written to. The cache and management layer 110 is arranged to translate the address parameters received from the hosts into logical addresses in the logical address space of the system (e.g., a logical block address (LBA) that indicates a block offset within the requested logical volume).

The cache and management layer 110 is further arranged to map the logical addresses of the logical address space to physical addresses of the physical address space. When a data unit is de-staged (sent from the cache and management layer 110 to be stored in the HDDs layer 120) the cache and management layer 110 maps the logical address of the data unit to a physical address. Alternatively, the cache and management layer 110 may translate the address parameters received from the host directly into physical addresses.

The cache and management layer 110 is illustrated as including a local snapshot module 114 and a local mirroring module 116. The local snapshot module 114 is arranged to create and delete local snapshots and the local mirroring module 116 is arranged to manage the provision of the local snapshots to the remote storage system 200 to provide remote snapshots.

The local storage system 100 includes a local communication module 113 that facilitates communication with remote storage system 200 and with the host computers 90(1)-90(Q). FIG. 3 illustrates the local communication module 113 as being included in the cache and management module layer 110 but this is not necessarily so. The remote storage system 200 includes a remote communication module 213 that facilitates communication with the local communication module 113.

Host computers 90(1)-90(Q) include host file system managers 92(1)-92(Q). Local storage system 100 includes a local file system manager 112, and remote storage system 200 includes a remote file system manager 212.

The local file system manager 112 can exchange information and commands with host file system managers 92(1)-92(Q) and with the remote file system manager 202 and allows end users of host computers 90(1)-90(Q) to execute file system commands on remote file system entities.

Data stored at the local storage system 100 can be treated as a local file system (denoted 122) while the data stored at the remote storage system 200 can be treated as a remote file system (denoted 222). Local storage system 100 can store data of more than one local filesystem and local file system manager 112 can handle more than one local filesystem. In the same manner, remote storage system 200 can store data of more than one remote filesystem and remote file system manager 212 can handle more than one remote filesystem. The local file system 122 can include data stored at the HDDs layer 120, at the cache and management layer 110 or in both layers.

Hybrid file system sub-tree 124 may include a representation of at least a part of the local file system 122 and at least a part of the remote file system 222. Hybrid file system sub-tree 124 may be regarded as including parts that belong to the local and remote file systems 122 and 222. The hybrid file system sub-tree 124 may include a virtual snapshots directory that represents (a) locally stored snapshots of entities of the local file system, and (b) at least one remote snapshot of at least one local file system entity that is stored at the remote storage system—as illustrated in FIG. 2.

According to embodiments of the present invention, the hosts can perform operations related to remote snapshots. Remote snapshot related operations are traditionally performed by a system administrator using a dedicated management interface, typically a WEB-interface and communicating over a dedicated management protocol, e.g. SMI-S (Storage Management Initiative—Specification), Json (JavaScript Object Notation) or a proprietary management protocol. A prior art host operator (end user) that needs to gain access to a snapshot, is required to contact the system administrator that has the facilities for accessing remote snapshots. Host computers(90) of the present invention can gain access to remote snapshots, without requiring system administrator's involvement, by using an in-band communication, i.e., by using standard file system commands that are generally available to end-users for accessing logical objects in a file system. Such standard file system commands can be for example the following NFS (Network File System) commands: READ/WRITE to a file, CREATE a file, MKDIR (create a directory), REMOVE a file, RMDIR (remove a directory), READDIR (read directory entries), READDIRPLUS (read directory entries along with their metadata) and any other commands that complies with any NAS standard. The access to remote snapshots is enabled by allowing host computers(90) to use standard file system commands that refer to remote virtual directories that represent remote snapshots.

The local communication module 113 may receive from a host computer 90(q) a file system command that is related to a remote snapshot of a local file system entity.

The local snapshot module 114 and the local mirroring module 116 are arranged to cooperate and to generate a remote snapshot of the local file system entity by a process that includes sending a snapshot of the local file system entity from the local storage system to a remote storage system.

The local file system manager 112 is arranged to respond to the file system command. The responding may include utilizing or generating remote snapshot file system information that is representative of the remote snapshot of the local file system entity. Non-limiting examples of file systems commands related to remote snapshots are listed below. The remote snapshot file system information is denoted 128 and may include, for example, a remote snapshot list (a list of available snapshot versions in the remote file system), a hybrid snapshot list (a list of available snapshot versions in the both the local and remote file system), a remote directory list (a list of directory-entries under a certain remote directory related to a specific snapshot), and the like.

According to an embodiment of the invention the local file system manager 112 may be arranged to request from the remote storage system (especially from the remote file system manager 212) the remote snapshot file system information in response to the receiving of the file system command.

According to another embodiment of the invention the local file system manager 112 can maintain the remote snapshot file system information 128 without assistance from the remote file system manager 212—but this may involve preventing the remote storage system 200 from changing a status of the remote snapshot of the local file system entity.

The local file system manager 112 may be arranged to manage a hybrid file system sub-tree that includes directories of the local file system (for example—directories 53A, 53B) and entities (directories and/or files) related to at least one remote snapshot of at least one local file system entity (for example—snapshot copies 30C and 30D of file F 30).

File system operations (triggered by file system commands sent to the local storage system) done on the hybrid file system sub-tree 124 and are related to a remote snapshot (30C, 30D) may be proxied to the remote storage system or otherwise impact the remote storage system that hosts the remote snapshots.

When an end user (via a host) tries to access a virtual remote directory or a virtual hybrid directory, a message may be sent by the local storage system to the remote storage system for retrieving the information and/or content requested for fulfilling the access request. Any file system command made on any virtual remote directory or virtual hybrid directory may be serviced in the same manner as would be done to any .snapshot directory.

The local storage system may maintain the hybrid file system sub-tree 124 with the assistance of the remote storage system or in an autonomous manner (but in that case the local storage system should be capable of controlling changes of statuses of the remote snapshots).

Examples of operations that can be made (in response to file system commands) on virtual remote directories include, for example, (a) list a virtual remote snapshots directory .snapshot that resides in the remote storage system, (b) list a content of a remote directory under the virtual snapshots directory .snapshot/remote/<snap-name>, (c) copy of remote files and/or remote directories from the remote file system to the local file system, (d) trigger a single snapshot replication, (e) delete a remote snapshot, and (f) create a remote snapshot. In the following examples, UNIX line-commands are used for demonstrating file system commands that can be initiated by the user. It is noted that any other user interface, including GUI (Graphical User Interface) instead of line-commands or commands supported by operation systems (or file systems) other than UNIX can be used for invoking file system commands.

Listing a Virtual Remote Snapshots Directory .snapshot that Resides in the Remote Storage System.

When a user wish to get a list of snapshot versions available in the remote storage system, in regard with a certain file system entity (e.g. directory), the user can initiate a directory list command that includes listing of a remote snapshots directory under a virtual hybrid snapshots directory .snapshot (e.g., “ls ./.snapshot/remote”) the local storage system initiates retrieval of a snapshot versions list of remote snapshots of the local file system that are stored in the remote storage system.

There may be few options for retrieving remote snapshot versions of the file system, some are listed below.

According to one embodiment, responsive to a user request for retrieving remote snapshot versions, the local storage system initiates sending a snapshot-list-request to the remote storage system and receiving from the remote storage system a snapshot list response that includes all the remote snapshot versions that exist in the remote storage system, optionally along with timestamps, indicative of the replication time of each snapshot.

According to a second embodiment, upon each generation of a remote snapshot, the version of the remote snapshot is registered in a remote snapshots list, managed by the local storage system. The remote snapshot versions list includes remote snapshot identification (e.g. remote snapshot version, remote snapshot name) for each remote snapshot, along with a timestamp, indicative of the time of generation of the remote snapshot. The remote snapshot versions list may be backed up in a persistent memory or a storage device, or may be otherwise requested from the remote storage system upon restart of the local storage system, after a local storage system failure.

When a directory-list command (ls) is issued for a remote snapshots directory, the remote snapshot versions list is obtained for displaying the available remote snapshots, optionally along with the time of replication. When a snapshot delete command is issued by the local storage system to the remote storage system, the corresponding entry is deleted from the remote snapshot versions list. The second embodiment may be applicable for cases where the remote storage system does not autonomously delete old remote snapshots (i.e. all the deletions are initiated only by the local storage system) or where the remote storage system informs the local storage system about any change in status (such as deletion) of the remote snapshots.

As a result of the listing command of a remote snapshots directory, the available remote snapshot versions are displayed to the user (e.g., ‘snap1 snap2’), optionally along with timestamps and other parameters.

Listing a Content of a Remote Directory that Resides Under the Virtual Remote Directory: .snapshot/remote/snap-name>.

When a user requests listing of content related to a remote directory under any remote virtual snapshots directory .snapshot (e.g., “ls ./.snapshot/remote/<snapshot-name>” or any sub-directory below <snapshot-name>) the local storage system initiates a remote retrieval of metadata content related to the requested remote directory under the specified virtual remote snapshot directory. The remote directory can be, for example, a virtual remote snapshot directory, a virtual remote sub-directory and the like.

A directory-list request that includes directory identification details of the directory to be listed is sent to the remote storage system. The directory identification details may include: (i) the remote file system identifier; (ii) actual path within the local file system. The actual path includes only real directories and omits virtual directories such as virtual remote directories. For example, if a user refers to a path “D0/.snapshot/remote/snap1/D1”, when the local storage system communicates with the remote storage system for accessing the requested directory (D1), the actual path used is: “/D0/D1” and the virtual portion of the path (in this case: “/.snapshot/remote/snap1/”) is omitted. The actual path does not include virtual directories that are accessible to the user because these virtual directory are not real directories and as such are not recognizable by the remote storage system; and (iii) snapshot-version, e.g., S1 or snapshot-name or any other snapshot identification.

The remote storage system may respond to the directory-list request with a directory-list response that includes a list of directory entries included in the remote directory.

Each directory entry may include: (i) the object name (e.g. a remote filename or a remote sub-directory name); (ii) optional, extended information to be displayed, e.g. timestamps (creation time, last update time, last access time, etc.), access permission, size of the file, and any other properties (as existed at the time the snapshot was taken) that may be displayed in an extended directory list; (iii) optional, an inode number for fast future access to the respective file.

Copy of Files/Directories from the Remote File System to the Local File System.

For purposes of recovering an older version of a file or even an entire sub-directory, a user can request copying a remote snapshot of a file or an entire remote directory or sub-directory, by using a regular copy command, e.g., “cp<source-location> <dest location>”, where the <source-location> refers to a path in the remote file system and the <destination location> refers to a path in the local file system. The <source location> may be, for example: ‘/D0/D1/.snapshot/remote/snap3/F’ and the destination location may be /D0/D1/F. In this specific example the current version of file F in the local storage system will be overwritten by the snapshot version of F as existed in snapshot version S3, as the destination directory, /D0/D1/, already includes a file having a name ‘F’.

The local storage system sends a get-object request to the remote storage system including the remote directory identification details as described above (e.g. file system identifier=xxx, actual path=“/D0/D1/F”; note that virtual directories are omitted) and snapshot version=S3. Alternatively, in case an inode number of the requested file is known (obtained from a previous directory list response), the path can be replaced with the inode number.

In response, the remote file system may send all data blocks and at least part of the metadata (e.g. the content of the inode) of file F as existed when snapshot S3 was taken.

The local storage system stores the data of the remote file in the HDD layer and stores the metadata along with pointers to the stored data blocks in the inode table. If the copy overwrites an existing local file, as in the example above, then the data of the local file is deleted and the old inode is overwritten with the new metadata.

If the copy command is of an entire remote sub-directory, the above process may be iterative, a get-object request is sent to the remote storage system, per each remote object included in the remote sub-directory. This process may be recursive in cases where the remote sub-directory includes lower level remote sub-directories.

Trigger a Single Snapshot Replication.

The user can initiate a single snapshot replication, by using a regular copy command that refers to (i) a virtual local snapshot directory, as a source directory of the copy command; and (ii) a virtual remote snapshot directory, as a destination directory of the copy command.

Typically the whole snapshot (of the entire directory tree of the local filesystem) is replicated by referring to a virtual local snapshot directory that resides under the root of the local file system (e.g. cp /.snapshot/<source-snap-version> .snapshot/remote/<remote-snap-version>). Optionally, only a sub-directory tree of the snapshot can be replicated and the command refers to the corresponding directory that serves as the root of this sub-tree (e.g., cp D0/D1/.snapshot/<snap-version> D0/D1/.snap shot/remote/<snap-version>, for replicating only D1 directory and the underlying objects in the specified snapshot version).

The local storage system then initiates a replication process with the remote storage system, with regard to the requested snapshot version. This replication process is identical to the regular replication process that is typically initiated automatically or initiated by the system administrator.

Remote Snapshot Creation.

A user can create a snapshot directly in the remote storage system (without needing to create a snapshot in the local storage system and replicate it to the remote storage system). The user will activate the creation of the remote snapshot, by using a create-directory command that includes a snapshot identification (name or version) and the path of the top level directory, which forms the sub-tree (or the whole file system) to be snapshot. Typically the snapshot applies to the whole file system, by referring, in the create-directory command to a virtual remote-directory that resides under the root of the file system (e.g. mkdir /.snapshot/remote/<remote-snap-version>).

Optionally, only a sub-tree of the file system can be snapshot and the command refers to the corresponding directory that serves as the root of this sub-tree (e.g. mkdir /D0/D 1/.snapshot/remote/<new snap-name>).

Upon activating the command, the local storage system sends a snapshot-creation command to the remote storage system, including the file system identifier, the actual path and the snapshot identification. In turn, the remote storage system triggers a snapshot creation process, based on the replicated file system that exists on the remote file system.

Deleting Remote Snapshots.

A user can delete a remote snapshot from the remote storage system by using a deletion command applied to a virtual remote directory.

Typically a snapshot of the entire file system is deleted by referring to a virtual remote-directory that resides under the root of the file system (e.g., rm /.snapshot/remote/<snap-version>). Optionally, only a sub-directory tree of the snapshot can be deleted and the command refers to the corresponding directory that serves as the root of this sub-tree (e.g., rm D0/D1/.snapshot/remote/<snap-version>, for deleting only D1 directory and the underlying objects from the replicated snapshot).

The local file system will send a snapshot delete request that includes the requested file system and snapshot version. If a deletion of a sub-directory tree is requested, then the request further includes the actual path. The remote file system will delete the requested snapshot version (or sub-directory tree) and optionally returns an acknowledgement including the snapshot version that was deleted. In case the local file system handled a replicated snapshots list, the entry that corresponds to the deleted snapshot version will be deleted.

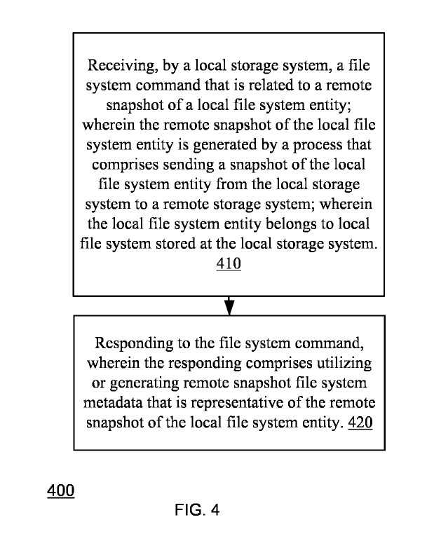

FIG. 4 illustrates method 400 according to an embodiment of the invention.

Method 400 may start by stage 410 of receiving, by a local storage system, a file system command that is related to a remote snapshot of a local file system entity; wherein the remote snapshot of the local file system entity is generated by a process that comprises sending a snapshot of the local file system entity from the local storage system to a remote storage system; wherein the local file system entity belongs to local file system stored at the local storage system.

Stage 410 may be followed by stage 420 of responding to the file system command, wherein the responding comprises utilizing or generating remote snapshot file system information that is representative of the remote snapshot of the local file system entity.

Stage 420 may include performing at least one out of the following operations: (a) listing a virtual remote snapshots directory .snapshot that resides in the remote storage system, (b) listing a content of a remote directory under the virtual snapshots directory .snapshot/remote/<snap-ver>, (c) copying of remote files and/or remote directories from remote file system to a local file system, (d) performing a single snapshot replication, (e) deleting a remote snapshot, and (f) creating a remote snapshot.

Stage 410 may include receiving a file system command that includes a request to copy the remote snapshot of the local file system entity from the remote storage system to the local storage system. Stage 420 may include requesting from the remote storage system to send to the local storage system the remote snapshot of the local file system entity.

The remote snapshot file system information is representative of the remote snapshot of the local file system entity. The remote snapshot file system information may be generated by the local storage system for various reasons including, for displaying information about the remote snapshot to an end user. The remote snapshot file system information can be used by the local storage system to execute various end user commands such as but not limited to triggering a single snapshot replication, copying of files/directories from the remote file system to the local file system, listing a content of a remote directory that resides under the virtual remote directory or listing a virtual remote snapshots directory .snapshot that resides in the remote storage system. The end user can refer to the remote snapshot using a path or a definition provided in the remote snapshot file system information and the local storage file system can then translate the end user commands using terms, paths or definitions acceptable by the remote storage system.

The invention may also be implemented in a computer program for running on a computer system, at least including code portions for performing steps of a method according to the invention when run on a programmable apparatus, such as a computer system or enabling a programmable apparatus to perform functions of a device or system according to the invention. A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A non-transitory computer readable medium that stores instructions for:
receiving, by a local storage system, a file system command that is sent from a host computer, the file system command is related to a remote snapshot of a local file system entity; wherein the remote snapshot of the local file system entity is generated by a process that comprises sending a snapshot of the local file system entity from the local storage system to a remote storage system; wherein the local file system entity belongs to a local file system stored at the local storage system; and
responding to the file system command, wherein the responding comprises utilizing or generating remote snapshot file system information that is representative of the remote snapshot of the local file system entity.

2. The non-transitory computer readable medium according to claim 1 that stores instructions for sending the snapshot of the local file system entity from the local storage system to the remote storage system.

3. The non-transitory computer readable medium according to claim 1 that stores instructions for requesting from the remote storage system the remote snapshot file system information in response to the receiving of the file system command.

4. The non-transitory computer readable medium according to claim 1 that stores instructions for requesting from the remote storage system the remote snapshot in response to the receiving of the file system command.

5. The non-transitory computer readable medium according to claim 1 that stores instructions for preventing the remote storage system from changing a status of the remote snapshot of the local file system entity.

6. The non-transitory computer readable medium according to claim 1 that stores instructions for generating a hybrid file system sub-tree that comprises (a) a local file system sub-tree that represents a portion of the local file system and (b) at least one remote file system sub-tree that represents at least one remote snapshot of at least one local file system entity.

7. The non-transitory computer readable medium according to claim 6 that stores instructions for sending to the host computer information that causes the host computer to display to the end user the hybrid file system tree.

8. The non-transitory computer readable medium according to claim 6 that stores instructions for generating the hybrid file system sub-tree to comprise a virtual snapshots directory that represents (a) locally stored snapshots of entities of the local file system, and (b) at least one remote snapshot of at least one local file system entity, wherein the at least one remote snapshot is stored at the remote storage system.

9. The non-transitory computer readable medium according to claim 1 that stores instructions for generating a remote file system sub-tree that represents at least one remote snapshot of at least one local file system entity.

10. The non-transitory computer readable medium according to claim 9 that stores instructions for sending to the host computer information that causes the host computer to display to the end user the remote file system sub-tree.

11. The non-transitory computer readable medium according to claim 9 wherein the remote file system sub-tree comprises a virtual directory that represents the at least one remote snapshot of the at least one local file system entity and wherein the file system command comprises a standard file system command and a reference to the virtual directory.

12. The non-transitory computer readable medium according to claim 1, wherein the system command is sent from a host computer without using system administrator privileges.

13. The non-transitory computer readable medium according to claim 1, wherein the file system command comprises a request to create the remote snapshot of the local file system entity and wherein the non-transitory computer readable medium stores instructions for responding to the file system command by sending the snapshot of the local file system entity from the local storage system to the remote storage system and generating the remote snapshot file system information.

14. The non-transitory computer readable medium according to claim 11 that stores instructions for responding to the file system command without generating a local snapshot of the local file system entity.

15. The non-transitory computer readable medium according to claim 1, wherein the file system command comprises a request to delete the remote snapshot of the local file system entity and wherein the non-transitory computer readable medium stores instructions for responding to the file system command by requesting from the remote storage system to deleted the remote snapshot of the local file system entity.

16. The non-transitory computer readable medium according to claim 1, wherein the file system command comprises a request to copy the remote snapshot of the local file system entity from the remote storage system to the local storage system; wherein the non-transitory computer readable medium stores instructions for responding to the file system command by requesting from the remote storage system to send to the local storage system the remote snapshot of the local file system entity.

17. A method, comprising: receiving, by a local storage system, a file system command that is related to a remote snapshot of a local file system entity; wherein the remote snapshot of the local file system entity is generated by a process that comprises sending a snapshot of the local file system entity from the local storage system to a remote storage system; wherein the local file system entity belongs to local file system stored at the local storage system; and responding to the file system command, wherein the responding comprises utilizing or generating remote snapshot file system information that is representative of the remote snapshot of the local file system entity.

18. A local storage system that comprises:
a communication module that is arranged to receive a file system command that is related to a remote snapshot of a local file system entity; wherein the remote snapshot of the local file system entity is generated by a process that comprises sending a snapshot of the local file system entity from the local storage system to a remote storage system; wherein the local file system entity belongs to local file system stored at the local storage system; and
a file system manager that is arranged to receive from the communication module the file system command and to manage a response to the file system command, wherein the response comprises utilizing or generating remote snapshot file system information that is representative of the remote snapshot of the local file system entity.
